(19) United States
(12) Patent Application Publication
(10) Pub. No.: US 2026/0330297 A1
(43) Pub. Date: Oct. 22, 2026

(54) Process Sequence Attribution Using State Value Function

(71) Applicant: International Business Machines Corporation, Armonk, NY (US)

(72) Inventors: Kohei Miyaguchi, Tokyo (JP); Masao Joko, Tokyo (JP); Tsuyoshi Ide, Harrison, NY (US)

(21) Appl. No.: 19/185,391

(22) Filed: Apr. 22, 2025

(51) Int. Cl. G06N 20/00

(52) U.S. Cl. CPC G06N 20/00

(57) ABSTRACT

A method trains a partial trajectory regression model. States are determined for a trajectory. Each state is a partial trajectory vector including process vectors for processes in the trajectory up to but excluding a target process. Actions are determined for the target processes. Each action is a process vector for the target process. Rewards are determined for the actions. Each reward for an action is given at a last target process in the trajectory. The reward is a negative defect metric of a defect metric associated with the trajectory. A training dataset comprises the states; the actions; the rewards; the trajectories used to determine the states, the actions, the rewards, and associated defect metrics for the trajectories. The partial trajectory regression model is trained according to the training data set. The partial trajectory regression model predicts defect metrics for partial trajectories using partial trajectory regression.

### BACKGROUND

The disclosure relates generally to manufacturing products and more specifically manufacturing semiconductors on wafers. Still more particularly, the present disclosure relates to identifying causes of defect densities for wafers with semiconductors resulting from sequential processes used to manufacture semiconductors.

In semiconductor device fabrication, a process trajectory, also known as processing route or path, defines a sequence of steps used to form integrated circuits on silicon wafers. Each of these processes is comprised of operations that can include, for example, polishing, ion implantation, fusion, etching, deposition, photolithography, cleaning, metallization, annealing, and other processes.

The cost of manufacturing semiconductor devices has continued to increase with ongoing technological advancements. In modern semiconductor fabrication facilities (fabs), the entire manufacturing process spans several months per wafer and requires specialized equipment and expensive materials.

In semiconductor manufacturing, a significant challenge arises when wafers that have already undergone multiple processing steps are later found to be defective due to a yield-degrading operation. This results in wasted time, energy, and materials not only for the affected wafers, but also for others processed before the issue is identified.

To address this issue, process-limited yields (PLYs), which are intermediate yield assessments, are conducted. These assessments are made after key processing steps such as gate formation. The results of these assessments can be used to evaluate the performance of specific process segments, particularly during research and development. While PLYs help isolate and identify steps that contribute to yield loss, these types of assessments are typically obtained through microscope-based inspection and followed by specialized defect classification analysis. This process can take hours or even days, depending on tool availability.

As a result, PLY checkpoints are usually placed only after major microstructures are formed, such as gates. Despite the introduction of intermediate inspection points, each PLY reflects the cumulative effect of tens or even hundreds of upstream processes, making it difficult to pinpoint the exact source of yield degradation. Currently, root-cause analysis of wafer defects often relies on a semi-brute-force approach, where large numbers of wafers are processed under varying process conditions to reproduce and investigate the issue.

### SUMMARY

According to one illustrative embodiment, a method trains a partial trajectory regression model. States are determined for a trajectory. Each state is a partial trajectory vector that includes process vectors for processes in the trajectory up to but excluding a target process. Actions are determined for the target processes in which each action is a process vector for the target process. Rewards are determined for the actions in which each reward for an action is given at a last target process in the trajectory and the reward is a negative defect metric of a defect metric associated with the trajectory. A training dataset comprises the states; the actions; the rewards; the trajectories used to determine the states, the actions, the rewards; and associated defect metrics for the trajectories. The partial trajectory regression model is trained according to the training data set, wherein the partial trajectory regression model predicts defect metrics for partial trajectories using partial trajectory regression. According to other illustrative embodiments, a computer system and a computer program product for training a partial trajectory regression model are provided.

According to another illustrative embodiment, A computer system comprises a processor set; a set of one or more computer-readable storage media; and program instructions stored in the set of one or more storage media to cause the processor set to perform operations. The processor set determines states for a trajectory, wherein each state is a partial trajectory vector that includes process vectors for processes in the trajectory up to but excluding a target process and wherein the trajectory is used in manufacturing semiconductor devices on a substrate. The processor set determines actions for the target processes in which each action is a process vector for the target process. The processor set determines rewards for the actions in which each reward for an action is given at a last target process in the trajectory and the reward is a negative defect metric of a defect metric associated with the trajectory. A dataset comprises the states; the actions; the rewards; the trajectories used to determine the states, the actions, the rewards; and associated defect metrics for the trajectories. The processor set trains the partial trajectory regression model according to the training data set, wherein the partial trajectory regression model predicts defect densities for partial trajectories using partial trajectory regression.

### BRIEF DESCRIPTION OF THE DRAWINGS

FIG. 1 is an illustration of partial trajectories in accordance with an illustrative embodiment;

FIG. 2 is an illustration of attribution score for a k-th process in accordance with illustrative embodiment;

FIG. 3 is a diagram of reinforcement learning used to train a partial trajectory regression model that predicts defect densities using partial trajectory regression in accordance with an illustration embodiment;

FIG. 4 is a graph that depicts defect densities scores for an average wafer in accordance with an illustrative embodiment;

FIG. 5 is a graph that depicts the defect density scores for the same average wafer as predicted by a partial trajectory regression model using reinforcement learning in accordance with an illustrative embodiment;

FIG. 6 is an example of a partial trajectory regression model that can be trained in a reinforcement learning module in accordance with an illustrative embodiment;

FIG. 7 is a block diagram of a computing environment in accordance with an illustrative embodiment;

FIG. 8 is a block diagram of a semiconductor manufacturing environment in accordance with an illustrative embodiment;

FIG. 9 is a flowchart of a process for training a predictive model in accordance with an illustrative embodiment;

FIG. 10 is a flowchart of a process for training the predictive model in accordance with an illustrative embodiment;

FIG. 11 is a flowchart of a process for training the predictive model in accordance with an illustrative embodiment;

FIG. 12 is a flowchart of a process for determining attribution scores in accordance with an illustrative embodiment;

FIG. 13 is a flowchart of a process for identifying responsible processes in accordance with an illustrative embodiment;

FIG. 14 is a flowchart of a process for manufacturing products in accordance with an illustrative embodiment;

FIG. 15 is a flowchart of a process for determining attribution scores in accordance with an illustrative embodiment;

FIG. 16 is a flowchart of a process for determining attribution scores in accordance with an illustrative embodiment; and

FIG. 17 is a flowchart of a process for training a predictive model in accordance with an illustrative embodiment.

### DETAILED DESCRIPTION

The illustrative embodiments recognize and take into account one or more different considerations in determining the root causes of wafer defects. for manufacturing semiconductors on wafers as described herein. Localizing the root causes of wafer defects is critical yet challenging due to multiple factors, including complex dependencies between processes, the heterogeneity of individual processes and recipes, and dynamic variations in processing routes.

A n attribution analysis can be used to determine what processes are responsible for defect metrics such as defect densities. The attribution analysis can use a prediction model to predict defect densities for wafters. This prediction model receives a trajectory of sequential processes used for manufacturing semiconductor devices as an input and predicts defect metrics for partial trajectories based on the sequential processes. Post processing logic can use the predicted defect densities to determine an attribution score for each process.

In training the prediction model, pairs of wafer histories and corresponding defect densities are collected to form a training dataset. A wafer history includes a sequence of processes in which each process has attributes. This wafer history can also be referred to as a trajectory. The attributes include, for example, equipment identifier (eqip_id, an integrated circuit recipe identifier (Icrecipe_id), a photolayer (photo_layer), a main process definition type (mainpd_type), and a completion timestamp.

Based on this training dataset, the prediction model is trained to predict defect density given an input trajectory of sequential processes up to a defect detection point of interest. This prediction model prediction partial trajectory regression and generates predictions of defect densities for partial trajectories. This prediction model is also referred to as a partial trajectory regression (PTR) model.

The output is defect densities for the partial trajectories determine using the input trajectory. The defect densities can be used to determine an attribution score for each process.

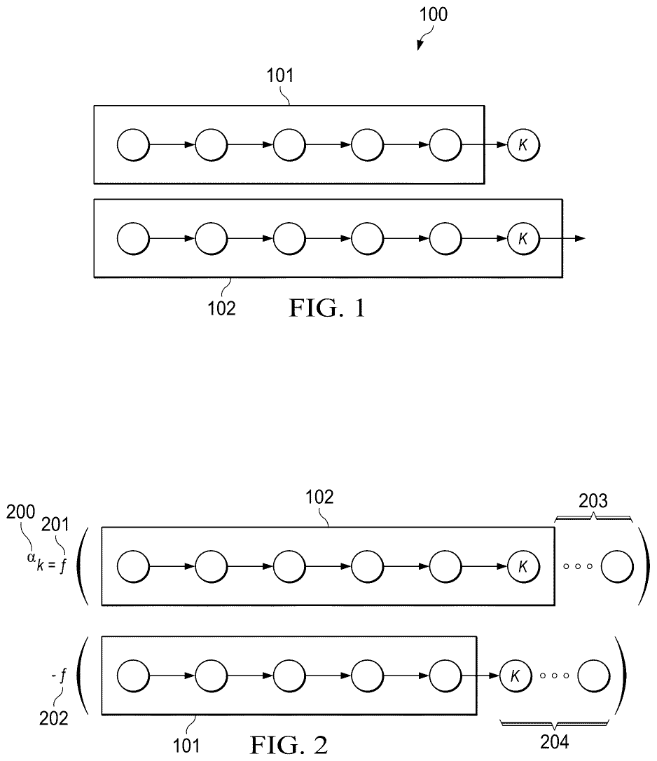

In FIG. 1, partial trajectories 100 are depicted in accordance with an illustrative embodiment. A partial trajectory is sequence of processes up to a selected process within the trajectory. Partial trajectory 102 starts at a first process and includes sequential processes after the first process up to and including target process k. Target process k is the last process in partial trajectory 102. Partial trajectory 101 includes the same sequential processes up to but excluding the target process k.

A prediction model implementing partial trajectory regression (PTR) quantifies a degree of causal intervention of the target process k on the observed defect density. This prediction model is also referred to as a partial trajectory regression model and predicts defect densities for these partial trajectories. In this example, a defect density is predicted for partial trajectory 101 and a defect density is predicted for partial trajectory 102.

The predicted defect densities for these two partial trajectories can be compared to each other to quantify the degree of causal intervention for target process k, which is the target process of interest for the defect density. This technique illustrated by partial trajectories 100 facilitates the identification of specific processes responsible for high defect densities, thereby supporting quality improvement initiatives.

Next in FIG. 2, an attribution score for a k-th process is depicted in accordance with illustrative embodiment. In the illustrative examples, the same reference numeral may be used in more than one figure. This reuse of a reference numeral in different figures represents the same element in the different figures.

In this example, attribution score (αₖ) 200 can be determined using the predicted defect densities between partial trajectory 102 and partial trajectory 101 in FIG. 1. Attribution score (αₖ) 200 can be determined as the difference between regression function 201 and regression function 202. In this example, downstream processes 203 in regression function 201 and downstream processes 204 in regression function 202 are not part of the partial trajectories and are “turned off” or “masked.”

The attribution score can be calculated for the k-th process (target process k). Let z_{1:t} be the partial trajectory up to the t-th process. The attribution score for the k-th process is defined as:

αₖ=ƒ(z_{1:k})−ƒ(z_{1:k-1})

where ƒ(z_{1:k}) is the regression function for the partial trajectory up to and including the k-th process and ƒ(z_{1:k-1}) is the regression function for the partial trajectory up to but not including the k-th process.

The regression function relies on an “aggregation function” to handle partial trajectories:

y_{1:t}=ƒ(z_{1:t})

where ƒ(z_{1:t}) is the regression function of wafer badness (defect density) implemented in the partial trajectory regression model, y_{1:t} is the hypothetical outcome for the partial trajectory z_{1:t}.

z_{1:t}=g(x₁, . . . ,xₜ;τ₁, . . . ,τₜ)

where g(⋅) is an aggregation function that generates the trajectory vector (route2vec vector) by “summarizing” the process history, incorporating upstream process vectors x₁, . . . , xₜ and time stamps τ₁, . . . , τₜ. The aggregation function can be arbitrary. In the illustrative example, a simple weighted sum is used.

The partial trajectory regression model uses a weighted sum model in a partial trajectory framework:

$${z}_{1 : k} = {\sum }_{i = 2}^{k} ψ ( {t}_{i} , {t}_{i - 1} ) {x}_{i}$$

where xᵢ: is the process vector (proc2vector) of the i-th process and ψ(tᵢ,t₁₋₁) is the weighting function, chosen as ψ(tᵢ,tᵢ₋₁)=log₁₀(tᵢ−tᵢ₋₁) with tᵢ being the process start time of the i-th process.

This implies setting downstream vectors xₖ₊₁, . . . x_{T} as zero:

$${z}_{1 : k} = {\sum }_{i = 2}^{T} ψ ( {t}_{i} , {t}_{i - 1} ) {x}_{i} if {x}_{k + 1} = … = {x}_{T} = 0$$

In this example, this setting of downstream vectors not part of the partial trajectory to zero may not provide the best prediction of defect densities. In creating process vectors, the zero vector represents the population mean (center of gravity). Further, the outcome heavily depends on the embedding method used. This situation introduces inconsistency and undermines interpretability. The use of “zero” is an arbitrarily provided value.

A method that can be used for partial trajectory regression is linear regression as follows:

y_{1:t}=θ^{T}z_{1:t}+b

where y_{1:t} is the hypothetical outcome for the partial trajectory z_{1:t}, θ regression coefficient vector, learned in the training phase, and b is regression coefficient intercept, learned in the training phase.

A partial trajectory regression model trained in this manner struggles to characterize wafers with defect densities close to the population average. In the illustrative examples, reinforcement learning techniques can be used to eliminate the arbitrariness and provide a much fairer rule in evaluating process k's impact.

The illustrative example defines attribution score (αₖ) 200 differently. Attribution score (αₖ) 200 is the difference between downstream processes 203 in regression function 201 and downstream processes 204 in regression function 202. However, in this example, the values for downstream processes 203 and downstream processes 204 are set using an optimal downstream path instead of being zeroed out. As a result, attribution score (αₖ) 200 measures the impact of the k-th process assuming that the rest of the downstream path is chosen optimally. In this example, attribution score (αₖ) 200 reflects as a best case scenario, regardless of what actually happened.

This definition is reminiscent of how a value function V(⋅) is defined in reinforcement learning (RL) in which V(s) is the cumulative reward when starting from state sand always taking the optimal action afterwards.

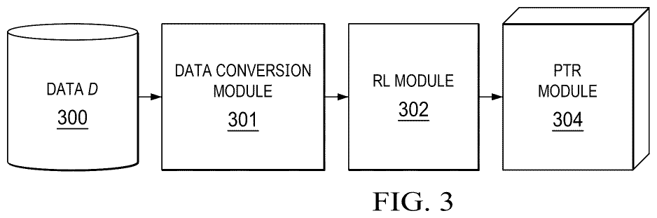

Turning to FIG. 3, a diagram of reinforcement learning used to train a partial trajectory regression model that predicts defect densities using partial trajectory regression is depicted in accordance with an illustrative embodiment. In this illustrative example, reinforcement learning is performed on partial trajectory regression (PTR) model 304 using data conversion module 301 and reinforcement learning (RL) module 302.

Database 300 stores trajectories with processes used to manufacture semiconductors on wafers and corresponding defect densities for the trajectories. Data conversion module 301 uses this data to generate a training dataset used by reinforcement learning (RL) module 302 to train PTR model 304.

In this example, data conversion module 301 generates states, actions, and rewards using the data stored in database 300. For example, the state, action, and reward for a k-the process is as follows:

$$State {s}_{k} ≡ {z}_{1 : k - 1} = {\sum }_{i = 2}^{k - 1} ψ ( {t}_{i} , {t}_{i - 1} ) {x}_{i} ,$$

$$Action {a}_{k} = ( {x}_{k} , {t}_{k} )$$

$$Reward {r}_{k} = \{ \begin{matrix}0 , & k \neq T \\ - y , & k = T\end{matrix} ,$$

where in State sₖ is a vector representing processes up to but excluding the k-th process; where in Action aₖ, xₖ is a vector for the k-th process and tₖ is a process start time; and where in Reward rₖ, −y is the negative defect density, T is the length of the trajectory, reward rₖ is given only at the last process.

In this example, the negative value function −V(sₖ₊₁) corresponds to the partial trajectory regression function y_{1:k}=ƒ(z_{1:k}) for a partial trajectory from 1 to k. Hence, the goal is to find the optimal value function. Although a policy function, which usually plays a central role in reinforcement learning, does not explicitly appear here, it is implicitly incorporated within the value function.

With a preference for positive attribution weights for interpretability, a constraint is used in which V(⋅) is decreasing along the path. Thus, the difference of the value function is parameterized:

V(sₖ₋₁)−V(sₖ)=g_{θ}(sₖ₋₁,sₖ),

where g_{θ}(⋅,⋅) is a function with a learnable parameter θ.

This can be implemented using a multi-layer perceptron as g_{θ}(⋅,⋅)=MLP_{θ}(⋅,⋅). The neural network parameter θ is learned so the cumulative reward is maximized. With this choice, the attribution score is computed as:

αₖ=g_{θ}(sₖ₋₁,sₖ)

In this example, RL module 302 can perform reinforcement learning neural network parameters for g_{θ}(sₖ₋₁,sₖ). From V(sₖ₋₁)−V(sₖ)=g_{θ}(sₖ₋₁,sₖ), the value function is represented as

$$V ( {s}_{k} ) = c - {\sum }_{j = 2}^{k} {g}_{θ} ( {s}_{j - 1} , {s}_{j} ) ,$$

where c=V(sᵢ) is treated as a model parameter along with θ.
Since the goal is to find V(⋅) and policy is not needed, the standard reinforcement learning (RL) algorithms such as the proximal policy optimization (PPO) algorithm is not appropriate. PPO is one of the mainstream RL algorithms and aims to find a policy that maximizes the cumulative reward. The value function can be found as a side product. Because a policy is not needed, approaches such as PPO are inefficient for use in RL learning in the illustrative examples.

Instead, RL module 302 uses value linear programing (V-LP). Assuming a training dataset containing N trajectory-defect density pairs:

$$D = {\{ \{ ( {x}_{1}^{( n )} , {t}_{1}^{( n )} ) , … , ( {x}_{{T}^{( n )}}^{( n )} , {t}_{{T}^{( n )}}^{( n )} ) \} , {y}^{( n )} \}}_{n = 1}^{N}$$

where

$${x}_{1}^{( n )}$$

is the process vector of the first process of the n-th wafer;

$${t}_{1}^{( n )}$$

is the process start time of the first process of the n-th wafer; T⁽ⁿ⁾ is the length of the process trajectory of the n-th wafer, and y⁽ⁿ⁾ is the actual defect density for the n-th trajectory measured at the last process of the n-th trajectory. In this example, the process vector can be determined using proc2vec as described in more detail below.

The objective function to be minimized is written as

$$L ( θ , c ) = \frac{1}{N} {\sum }_{n = 1}^{N} [ \frac{λ}{{T}^{( n )}} {\sum }_{t = 1}^{{T}^{( n )}} V ( {s}_{k} ) + {\{ V ( {s}_{k} ) - {y}^{( n )} \}}^{2} ]$$

where N is the total number of trajectories, n is an index for trajectories, T⁽ⁿ⁾ is the value for length of n-th trajectory, tis an index for processes in n-th trajectory, sₖ is the trajectory vector for k−1 th process, V(sₖ) is the predicted defect density for partial trajectory that includes k−1 th process, and λ is a weight.

In this example, the objective function is minimized during training of the PTR model 304 to find optimal values for model parameter cand the set of learnable parameter θ in the value function (V(s_k)=c−Σ_(j=2)\hat{ }k [symbol] [symbol] g_θ(s_(j−1),s_j)) [symbol] . In this case, the training dataset D is used by the objective function and the reinforcement learning involves a process in RL module 302 iteratively updating the set of learning parameters θ and the model parameter c to see if the loss output by the objective function is minimized. RL module 302 inputs trajectories from database 300 into PTR model 304. Defect densities for partial trajectories are output. These results are used by RL module 302 in performing reinforcement learning. In this case, the loss output from the objective function corresponds to the cumulative rewards that is to be minimized during the reinforcement learning.

As a result, after the reinforcement learning, optimal values for the set of learnable parameters θ and the model parameter c can be obtained for the value function (V(s_k)), where

$$V ( {s}_{k} ) = c - {\sum }_{j = 2}^{k} {g}_{θ} ( {s}_{j - 1} , {s}_{j} )$$

can be used to predict defect density for an input partial trajectory that include up to k-th process. In this case, the value function (V(s_k)) can be used in the regression function in PTR model 304 for predicting defect density. Subsequently, the functions of attribution score (V(sₖ₋₁)−V(sₖ)) can be used for calculating attribution scores for the input partial trajectory that includes up to k-th process.

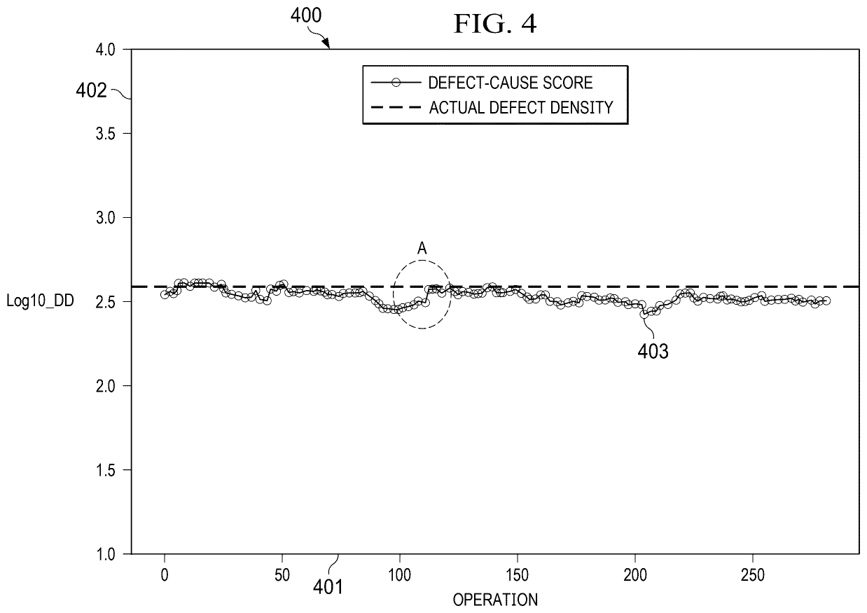

Thus, the illustrative examples use a reinforced learning technique that overcomes this issue. In FIG. 4, graph 400 shows defect densities scores for an average wafer in accordance with an illustrative embodiment. In this example, the wafer is an average wafer in which defect density does not change much during processing.

As depicted, x-axis 401 is the operation and y-axis 402 is defect densities. In this example, line 403 represents the defect density predicted for an average wafer as predicted by a partial trajectory regression model using linear regression. The model has not been trained using RL module 302 in FIG. 3. In this example, the process at A does not show a significant amount of change in defect density.

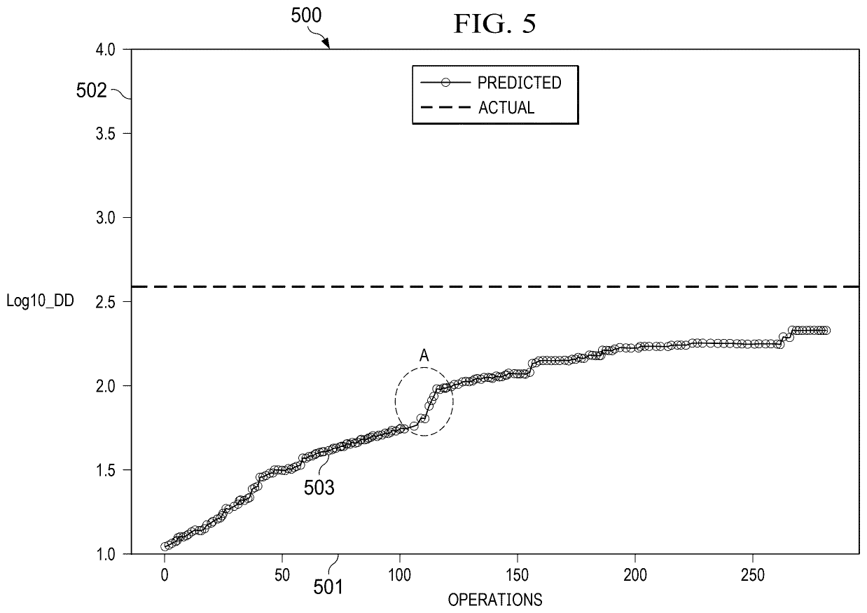

Next in FIG. 5, graph 500 depicts the defect density scores for the same average wafer as predicted by a partial trajectory regression model using reinforcement learning in accordance with an illustrative embodiment. As shown, x-axis 501 is the operation and y-axis 502 is defect densities. Line 503 shows defect densities for the same average wafer for which predictions were made in FIG. 4.

In this example, these defect densities are predicted by a partial trajectory regression model using linear regression that has been trained by RL module 302 in FIG. 3. Further, RL module 302 performs the training using data generated by the data conversion module 301 in FIG. 3.

As illustrated, the process at A shows a significant amount of change in defect density as compared to the same process at A for line 403 in FIG. 4. In this example, the issues with predicting defect densities close to the population average are not present as illustrated by line 503. With this type of training using reinforce learning as described above, the defect density change for the process that label A is easier to identify for this average wafer.

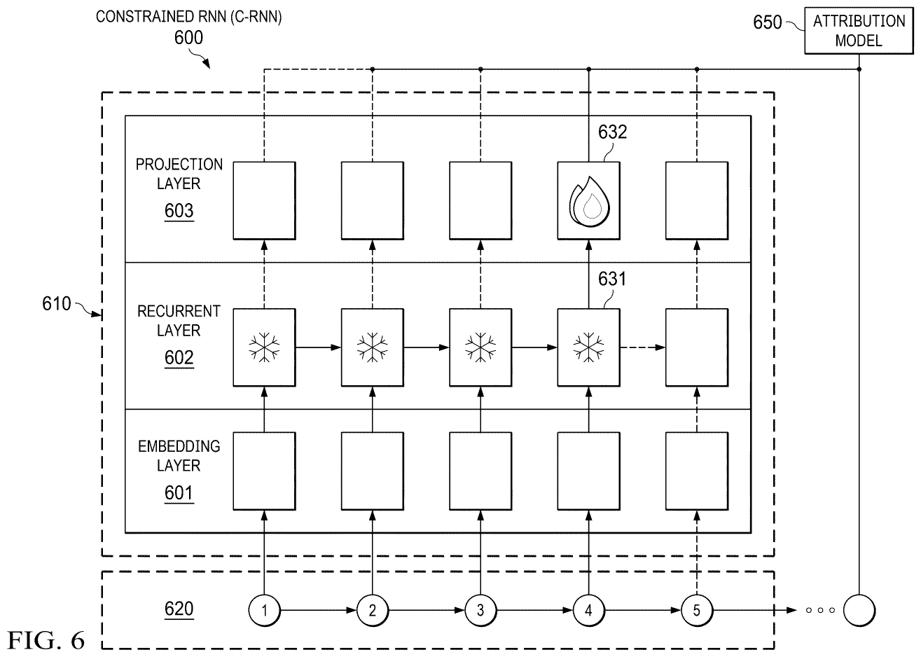

FIG. 6 is an example of a partial trajectory regression model that can be trained by a reinforcement learning module in accordance with an illustrative embodiment. In this example, constrained-recurrent neural network (C-RNN) 600 is a partial trajectory regression model that can be trained by RL module 302 using a training dataset created by data conversion module 301 in FIG. 3.

C-RNN 600 generates predictions of defect densities for partial trajectories using partial trajectory regression. These defect densities predicted for the partial trajectories can be used to calculate an attribution score for each process in the process history for a trajectory. As depicted in FIG. 6, C-RNN 600 is comprised of embedding layer 601, recurrent layer 602, and projection layer 603. In this example, each of these layers is comprised of cells 610.

Embedding layer 601 provides process embedding and is formed from one or more embedding layers. In this depicted example, embedding layer 601 receives a trajectory in the form of a string. This string describes the sequential processes in a trajectory and the attributes for those processes in the trajectory. Embedding layer 601 creates process vectors that represent the processes in the trajectory. In this illustrative example, the process vector is a numerical representation of a process and its attributes. Embedding layer 601 can implement various processes to create vector representations of the processes. In this example, embedding layer 601 can be implemented using Proc2Vec. Embedding layer 601 can handle a diversity of trajectories and capture implicit similarities between the description of processes in trajectories.

In this illustrative example, Proc2Vec is a function that generates a vector representation for each process using a kernel embedding technique. In kernel embedding, data points such as words are mapped into a continuous vector space using kernel methods. These kernel methods are machine learning techniques that transform data into a higher-dimensional feature space using kernel functions that compute the similarity between two data points in an implicit high-dimensional space without explicitly mapping them.

Common process attributes across different processes are extracted. Process attributes can be available from the manufacturing execution system. These process attributes can include at least one of equipment identifiers, recipe identifiers, tool types, photo layer identifiers, and route identifiers, or other process attributes.

These process attributes are concatenated into a single string representing each process:

(process token)=eqp⊕recipe⊕tool_type⊕photo_layer⊕route⊕ (3)

where ⊕ denotes concatenation with a suitable separator.

In this depicted example, based on the string representation a dictionary of the tokens is constructed. Let V_{d} be the size of the vocabulary, i.e., the number of unique tokens. For the dictionary, a kernel matrix is constructed between processes based on the string representation. The kernel matrix K∈ [symbol] , where K_{i,j} is the similarity between token i and token j.

Once the kernel matrix is computed, the vector representation of process i is obtained as follows:

$${x}_{i} = {( \sqrt{{λ}_{1}} {v}_{i}^{( 1 )} , … , \sqrt{{λ}_{k}} {v}_{i}^{( k )} , … , \sqrt{{λ}_{D}} {v}_{i}^{( D )} )}^{T} \qquad ( 4 )$$

where λₖ is the k-th largest eigenvalue of K, and

$${v}_{i}^{( k )}$$

is the i-th element of the eigenvector corresponding to λₖ. D is the embedding dimensionality as a hyperparameter. This mapping from process i to its vector representation xᵢ is referred to as Proc2Vec. Thus, using Proc2Vec, a process trajectory ξ is represented as an ordered set of processes with associated process completion times.

In this illustrative example, recurrent layer 602 implements regression modeling using process vectors generated by embedding layer 601. With processes having been converted from a string form into D-dimensional vectors, a predictive model is implemented for defect density y as a function of the sequence of the process vectors. Recurrent layer 602 can handle the variable length of trajectories, making this trajectory regression technique different from current regression techniques.

Recurrent layer 602 can create partial trajectories used to predict defect densities. In these examples, partial trajectories are generated by incrementally including a next process in the sequences of processes. The generation of partial trajectories can be performed using a function Route2Vec implemented in recurrent layer 602. The Route2Vec converts the entire trajectory, represented as an ordered set of process vectors, into a trajectory vector representation. In this illustrative example, a constrained-recurrent neural network (C-RNN) is used where each cell operates as:

zₖ=Cell(zₖ₋₁,xₖ,tₖ) (5)

where zₖ is the vector representation of the partial trajectory up to the k-th process from the first process. As a result, the vector representation of the full trajectory of ξ⁽ⁿ⁾ is obtained as

$${z}^{( n )} := {z}_{{L}^{( n )}}^{( n )} .$$

In these examples, this mapping from a (partial or full) trajectory zₖ (k=1, . . . , L) is referred to as route2vec.

In the illustrative examples, a cell architecture for cells 610 is used as follows:

zₖ=ψ(tₖ,tₖ₋₁)xₖ+zₖ₋₁ (6)

where y(⋅,⋅) is a temporal mapping function set to log₁₀(1+⋅). Equation (6) can be extended to more expressive models such as multi-layer perceptrons (MLP).

Projection layer 603 provides a prediction of the defect density based on vectors for the partial trajectories received from recurrent layer 602. Thus, projection layer 603 outputs a defect density for each partial trajectory received from recurrent layer 602. In these examples, a defect density represents the defect density present after the last process in the sequence of processes in a partial trajectory. As a result, defect densities can be used to determine which process or processes are responsible for the defect density of the input trajectory.

The regression function in recurrent layer 602 defines a function to predict defect density y from ξ. Since route2vec converts trajectories of varying lengths into fixed-dimension vectors, the prediction function can be formulated as:

ƒ(zₖ)=MLP(zₖ) (7)

where MLP denotes a multi-layer perceptron. In this example, a fully connected network is used without hidden layers. This network defines a linear prediction function. Further, notation for the function ƒ(⋅) can be for both a full trajectory and partial trajectories. The function ƒ(⋅) in recurrent layer 602 is trained to minimize a properly regularized squared loss such as:

$$L := \frac{1}{2 N} {\sum }_{n = 1}^{N} {\sum }_{k = 1}^{{L}^{( n )}} \frac{1}{{L}^{( n )}} {( {y}^{( n )} - f ( {z}_{k} ) )}^{2} + v {‖ θ ‖}_{1} \qquad ( 8 )$$

where θ is the model parameters in ƒ(⋅) and ∥⋅∥₁ is the l₁-norm. vis the regularization strength and is treated as a hyperparameter. The inner summation represents data augmentation for numerical stability.

In this example, C-RNN 600 provides an ability to receive partial trajectories as an input trajectory. To quantify the influence of the k-th process, a determination can be made as to whether a significant difference in the prediction outcome between the partial trajectories zₖ and zₖ₋₁ is present. For example, a determination can be made as to whether a difference in the prediction of defect densities between the partial trajectories exceeds a threshold. This threshold is set as one in which the difference is sufficiently significant such that the k-th process is considered responsible for the defect density for the wafer. This comparison between two counterfactual inputs measures the potential outcome when including process k.

In this example, attribution model 650 can be used to process the outputs from C-RNN 600 to determine respective attribution scores for the processes in a trajectory. Attribution model 650 can receive the defect densities output by projection layer 603. The attribution score for a process can be directly calculated as the difference of defect densities between a first trajectory with processes up to, but excluding, the process in question, and a second trajectory with processes up to and including the process.

This quantification can be made following Rubin's potential outcome framework, which is also referred to as Rubin Causal Model (RCM). The attribution model quantifies the causal intervention of process kas follows:

αₖ(ξ)=ƒ(zₖ)−ƒ(zₖ₋₁) (9)

where k is the process index and ƒ(zₖ) is the defect density prediction for partial trajectory k and ƒ(zₖ₋₁) is the defect density prediction for the partial trajectory without process k. This equation defines the attribution score of the k-th process in trajectory ξ. This attribution score satisfies the following additive property:

Theorem III.1 (Additive Property of PTR). The PTR attribution score satisfies the additive property:

$${\sum }_{l = 1}^{k} {α}_{l} = f ( {z}_{k} ) - f ( {z}_{0} ) \qquad ( 10 )$$

This proof is obtained from directly summing individual contributions:

$${\sum }_{l = 1}^{k} {α}_{l} = [ f ( {x}_{k} ) - f ( {z}_{k - 1} ) ] + [ f ( {z}_{k - 1} ) - f ( {z}_{k - 2} ) ] + … + [ f ( {z}_{1} ) - f ( {z}_{0} ) ] = f ( {z}_{k} ) - f ( {z}_{0} ) \qquad ( 11 )$$

This additive property significantly enhances the interpretability of the attribution score as shown below in FIG. 3.

In the example in FIG. 6, trajectory 620 is input into embedding layer 601. In this example, trajectory 620 includes process 1, process 2, process 3, process 4, and process 5. Each of these processes are converted into process vectors by cells 610 in embedding layer 601.

These process vectors are sent to cells 610 in recurrent layer 602, which uses the process vectors to create partial trajectory vectors for partial trajectories. For example, the cells up through cell 631 in recurrent layer 602 compute a partial trajectory that includes processes up to and including process 4.

A cell operates as follows:

$${z}_{1 : k}^{( n )} = {z}_{1 : k - 1}^{( n )} + {log}_{10} ( {t}_{k}^{( n )} - {t}_{k - 1}^{( n )} ) {x}_{k}^{( n )} \qquad ( 12 )$$

where

$${x}_{k}^{( n )}$$

is the process vector of the k-th process,

$${z}_{1 : k - 1}^{( n )}$$

is the trajectory vector of the trajectory from first process up to the k−1 th process;

$$( {t}_{k}^{( n )} - {t}_{k - 1}^{( n )} )$$

are a difference in timestamps between k-th process and k−1-th process; k is the index for a process in a trajectory; n is the index for trajectories; and tare time stamps.

In this example, a selected cell receives a partial trajectory vector

$${z}_{1 : k - 1}^{( n )}$$

from one cell to the left of the selected cell and receives the process vector

$${x}_{k}^{( n )}$$

from another cell in a lower layer that is below the selected cell. The output from the selected cell is

$${z}_{1 : k}^{( n )}$$

which is the partial trajectory vector up to the k−1 process.

This definition for cells 610 enables recurrent layer 602 to handle partial trajectories since

$${z}_{1 : k}^{( n )}$$

can bethought of as the internal state up to the k-th process. Equation (12) can be generalized into

$${z}_{1 : k}^{( n )} = {z}_{1 : k - 1}^{( n )} + {ψ ( {t}_{k}^{( n )} - {t}_{k - 1}^{( n )} ) 〚 ϕ ( x 〛}_{k}^{( n )} ) ,$$

with φ, ψ being learnable function such as multi-layer perceptrons (MLPs).

The separation of the time duration is due to specific needs of semiconductor manufacturing. Leaving wafers unprocessed for a long time can negatively affect the final quality. This specific parameterization is one of the unique features in these illustrative examples.

In this example, projection layer 603 determines predicted defect densities for the trajectory vectors representing the partial trajectories. For example, cell 632 in projection layer 603 computes the defect density for the partial trajectory vector that includes processes up to and including process 4.

In this example, a prediction of a defect density output by cell 632 can be made for detection point 670. This detection point is a point in the process where defect densities are detected.

The illustration of C-RNN 600 in FIG. 6 is provided as an example of an implementation for a partial trajectory regression model that predicts defect metrics such as defect densities and is not meant to limit the manner in which other illustrative examples can be implemented. A Iso, other types of prediction models can be implemented to handle partial trajectories using a partial trajectory regression in other illustrative examples.

For example, although a single layer is shown for projection layer 603, recurrent layer 602, and embedding layer 601, these different types of layers can include one or more layers in addition to the ones illustrated in some examples.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

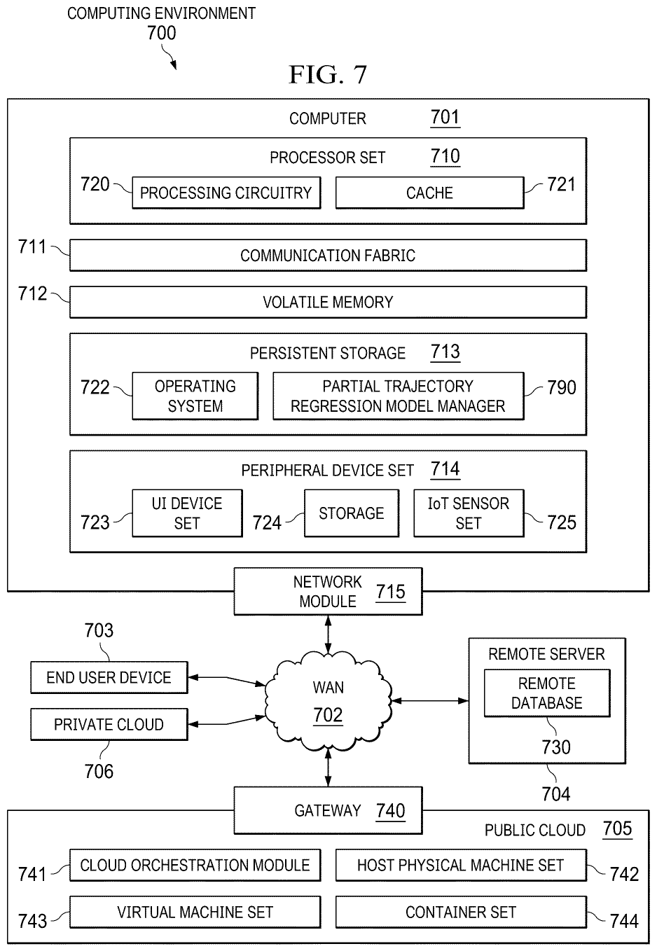

With reference now to the figures in particular with reference to FIG. 7, a block diagram of a computing environment is depicted in accordance with an illustrative embodiment. Computing environment 700 contains an example of an environment for the execution of at least some of the computer code involved in performing the inventive methods, such as partial trajectory regression model manager 790. In addition to partial trajectory regression model manager 790, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and partial trajectory regression model manager 790, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer-readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in partial trajectory regression model manager 790 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in partial trajectory regression model manager 790 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SA N) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer-readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LAN s) designed to communicate data between devices located in a local area, such as a Wi-Fi network. The WAN and/or LAN s typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EU D 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EU D 703 can display, or otherwise present, the recommendation to an end user. In some embodiments, EU D 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the V C E. Cloud orchestration module 741 manages the transfer and storage of images, deploys new instantiations of VCEs and manages active instantiations of V C E deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

CLOUD COMPUTING SERVICES AND/OR MICROSERVICES: Public cloud 705 and private cloud 706 are programmed and configured to deliver cloud computing services and/or microservices (not separately shown in FIG. 7). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

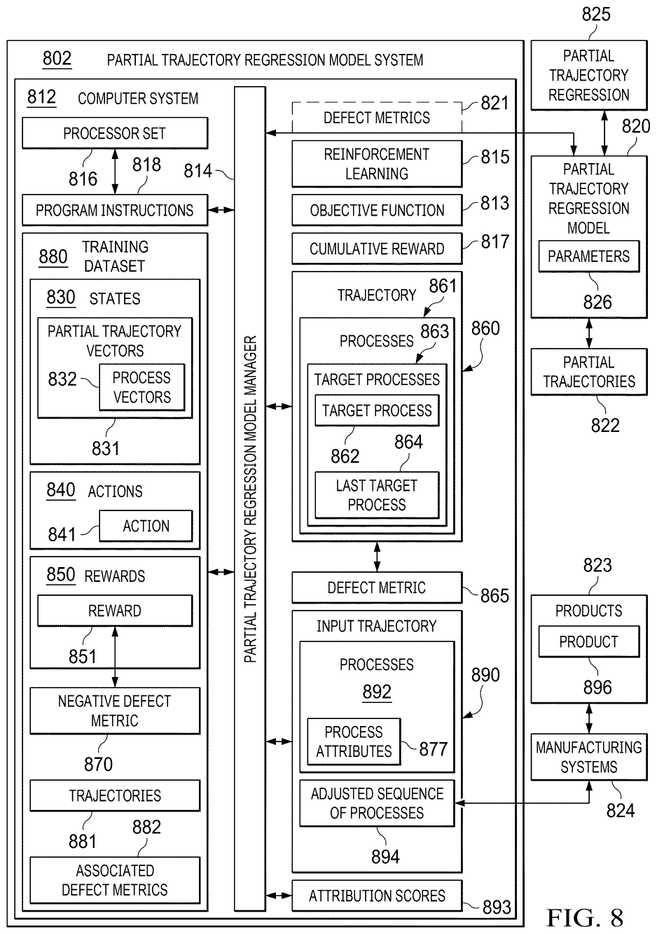

With reference now to FIG. 8, a block diagram of a semiconductor manufacturing environment is depicted in accordance with an illustrative embodiment. In this illustrative example, partial trajectory regression model system 802 includes components that can be implemented in hardware such as the hardware shown in computing environment 700 in FIG. 7.

In this example, partial trajectory regression model system 802 can operate to at least one of train or use partial trajectory regression model 820 to predict defect metrics for products 823 manufactured by manufacturing systems 824. This prediction can be made using partial trajectory regression model 820.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In this illustrative example, partial trajectory regression model 820 can take a number of different forms. Partial trajectory regression model 820 can be selected from a group comprising a constrained recurrent neural network, sequential regression model, a neural network, a recurrent neural network (RNN), a constrained neural network, a long-short term memory (LSTM) network, or a transformer model, or other suitable types of prediction models that can handle partial trajectories. For example, partial trajectory regression model 820 can be implemented using C-RNN 600 in FIG. 6.

These defect metrics can be for example, defect density; defects per unit, defect kill ratio, defect distribution size, defect rate, first pass yield, and other suitable metrics that provide information. Manufacturing systems 824 can be selected from a group comprising a semiconductor manufacturing system, an automobile manufacturing system, a pharmaceutical manufacturing system, a food processing system, a metal fabrication system, a plastics manufacturing system, a chemical production system, and other types of systems in which metrics such as defect metrics are monitored for product quality.

In this illustrative example, partial trajectory regression model system 802 comprises computer system 812 and partial trajectory regression model manager 814. As depicted, partial trajectory regression model manager 814 is located in computer system 812. Partial trajectory regression model manager 814 may be implemented using partial trajectory regression model manager 790 in FIG. 7.

Partial trajectory regression model manager 814 can be implemented in software, hardware, firmware or a combination thereof. When software is used, the operations performed by partial trajectory regression model manager 814 can be implemented in program instructions configured to run on hardware, such as a processor unit. When firmware is used, the operations performed by partial trajectory regression model manager 814 can be implemented in program instructions and data and stored in persistent memory to run on a processor unit. When hardware is employed, the hardware can include circuits that operate to perform the operations in partial trajectory regression model manager 814.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Computer system 812 is a physical hardware system and includes one or more data processing systems. When more than one data processing system is present in computer system 812, those data processing systems are in communication with each other using a communications medium. The communications medium can be a network. The data processing systems can be selected from at least one of a computer, a server computer, a tablet computer, or some other suitable data processing system.

As depicted, computer system 812 includes processor set 816 that is capable of executing program instructions 818 implementing processes in the illustrative examples. In other words, program instructions 818 are computer-readable program instructions. Processor set 816 is an example of processor set 710 in FIG. 7.

As used herein, a processor unit in processor set 816 is a hardware device and is comprised of hardware circuits such as those on an integrated circuit that respond to and process instructions and program code that operate a computer. Processor set 816 can be a number of processor units that can be implemented using processor set 710 in FIG. 7. The processor units can also be referred to as computer processors. When processor set 816 executes program instructions 818 for a process, processor set 816 can be one or more processor units that are in the same computer or in different computers. In other words, the process can be distributed between processor units in processor set 816 on the same or different computers in computer system 812.

Further, processor set 816 can include the same type or different types of processor units. For example, processor set 816 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 816 can also include other components in addition to the processor units or processing circuitry. For example, processor set 816 can also include a cache or other components used with processor units or other processing circuitry.

In one example, partial trajectory regression model manager 814 can determine states 830 for trajectory 860. With this example, states 830 are partial trajectory vectors 831 that include process vectors 832 for processes 861 in trajectory 860. These processes are sequential processes in these examples. Each state in states 830 is a partial trajectory vector that includes process vectors 832 for processes 861 in the trajectory 860 up to but excluding target process 862.

Further, partial trajectory regression model manager 814 determines actions 840 for target processes 863 in which each action in actions 840 is a process vector for target process 835.

Partial trajectory regression model manager 814 also determines rewards 850 for actions 840. Reward 851 for action 841 is given at a last target process 864 in trajectory 860 and reward 851 is a negative defect metric 870 of defect metric 865 associated with trajectory 860.

In this example, training dataset 880 comprises states 830, actions 840; rewards 850; and trajectories 881 used to determine states 830, actions 840, rewards 850; and associated defect metrics 882 for trajectories 881. Partial trajectory regression model manager 814 trains partial trajectory regression model 820 according to training dataset 880.

In this example, this training of partial trajectory regression model can be performed using reinforcement learning 815 and training dataset 880. For example, partial trajectory regression model manager 814 sends trajectory 860 as an input into partial trajectory regression model 820. Partial trajectory regression model manager 814 receives defect metrics 821 as an output from partial trajectory regression model 820. Partial trajectory regression model manager 814 evaluating objective function 813 based cumulative reward 817 from actions 840.

Partial trajectory regression model manager 814 adjusts a number of parameters 826 in the partial trajectory regression model 820 to minimize the objective function. The particular parameters adjusted can be selected as any of a number of parameters 826 that affect the value generated by evaluating objective function 813.

In this illustrative example, partial trajectory regression model manager 814 repeats sending, receiving, evaluating, and adjusting until objective function 813 is minimized. In this example, objective function 813 is minimized when the predictions of defect metrics 821 are close as desired such as within some threshold to the measured defect densities. In other words, minimizing objective function 813 means obtaining the smallest possible value from objective function 813. In other examples, objective function 813 can be considered minimized when the value of the objective function that falls within a predefined tolerance of the optimal solution.

After training, partial trajectory regression model 820 predicts defect metrics 821 for partial trajectories 822 using partial trajectory regression 825. For example, defect metrics 821 can be predicted for partial trajectories 822 that are generated using trajectory 860.

In one illustrative example, partial trajectory regression model manager 814 receives input trajectory 890. In this example, input trajectory 890 comprises a sequence of processes 892 for manufacturing product 896. Partial trajectory regression model manager 814 predicts defect metrics 821 for processes 892 in input trajectory 890 using partial trajectory regression model 820 trained with training dataset 880. Partial trajectory regression model 820 predicts defect metrics 821 for the sequence of processes 892 in input trajectory 890 using partial trajectory regression 825. Partial trajectory regression model 820 determines attribution scores 893 for the sequence of processes 892 in input trajectory 890 using defect metrics 821 predicted by partial trajectory regression model 820. In this example, attribution scores 893 indicate a responsibility of processes 892 in the sequence of processes 892 for a defect metric for product 896.

Further in this example, partial trajectory regression model manager 814 identifies a number of processes 892 in the sequence of processes 892 responsible for the defect metric for product 896 using attribution scores 893.

In this example, the sequence of processes 892 in input trajectory 890 is for manufacturing product 896 in a manufacturing system in manufacturing systems 824. With this example, partial trajectory regression model manager 814 adjusts a number of process attributes 877 for the number of processes 892 in the sequence of processes 892 identified as being responsible for the defect metric to form adjusted sequence of processes 894. Partial trajectory regression model manager 814 manufactures products 823 in the manufacturing system using adjusted sequence of processes 894.

Computer system 812 can be configured to perform at least one of the steps, operations, or actions described in the different illustrative examples using software, hardware, firmware or a combination thereof. As a result, computer system 812 operates as a special purpose computer system in which partial trajectory regression model manager 814 in computer system 812 enables controlling manufacturing of products using trajectories comprising processes that are performed to manufacture those products. In these illustrative examples, these trajectories defect metric predictions can be made for partial trajectories derived from these trajectories. The defect metric predictions can be used to determine responsibility of particular processes that are responsible for undesired defect metrics. Thus, adjustments can be made to the trajectories to reduce defects in manufacturing products.

The illustration of partial trajectory regression model system 802 in FIG. 8 is not meant to imply physical or architectural limitations to the manner in which an illustrative embodiment can be implemented. Other components in addition to or in place of the ones illustrated may be used. Some components may be unnecessary. A Iso, the blocks are presented to illustrate some functional components. One or more of these blocks may be combined, divided, or combined and divided into different blocks when implemented in an illustrative embodiment.

For example, input trajectory 890 is comprised of a sequence of processes 892 for manufacturing various types of products 823 using manufacturing systems 824. For example, input trajectory 890 can comprise a sequence of processes 892 for manufacturing semiconductor devices on substrates. In another example, input trajectory 890 can comprise a sequence of processes 892 for a vehicle. In yet other illustrative examples, input trajectory 890 can comprise of a sequence of processes 892 for manufacturing other types of products 823 such as pharmaceuticals, consumer products, parts, and other types of products 823.

As another example, input trajectory 890 can be had partial trajectory. In other words, input trajectory 890 can comprise a portion of the total processes used to manufacture a product. For example, input trajectory 890 can be a sequence of processes 892 that are a subset of the total processes used to manufacture the product. In this manner, predictions of defect metrics can be made for a portion of a manufacturing process when input trajectory 890 is a partial trajectory.

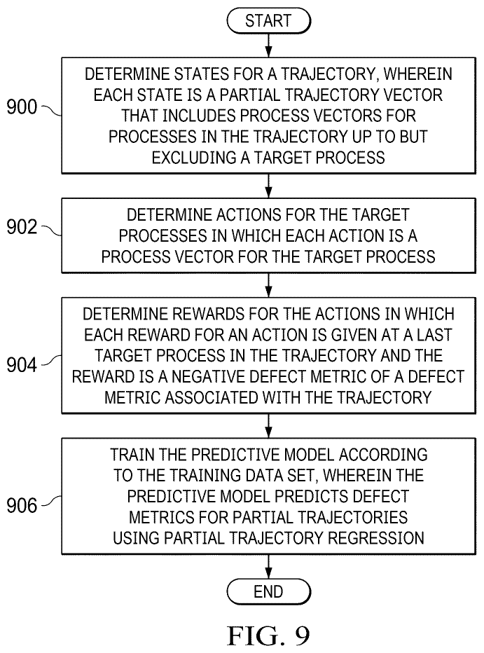

Turning next to FIG. 9, a flowchart of a process for training a predictive model is depicted in accordance with an illustrative embodiment. The process in FIG. 9 can be implemented in hardware, software, or both. When implemented in software, the process can take the form of program instructions that are run by a processor set located in one or more hardware devices in one or more computer systems. For example, the process can be implemented in partial trajectory regression model manager 814 in computer system 812 in FIG. 8.

The process determines states for a trajectory, wherein each state is a partial trajectory vector that includes process vectors for processes in the trajectory up to but excluding a target process (step 900). The process determines actions for the target processes in which each action is a process vector for the target process (step 902).

The process determines rewards for the actions in which each reward for an action is given at a last target process in the trajectory and the reward is a negative defect metric of a defect metric associated with the trajectory (step 904). In step 904, the defect metrics are selected from a group comprising a defect density, defects per unit, a defect kill ratio, a defect distribution size, and other metrics for measuring the goodness of a product such as a wafer with semiconductor devices.

The training dataset comprises the states; the actions; the rewards; the trajectories used to determine the states, the actions, the rewards; and associated defect metrics for the trajectories. The state is for a partial trajectory of a previous process to the target process. In this example, a partial trajectory vector includes process vectors for processes up to but excluding a target process in a trajectory. The target process is the kth process in one example, The last action (process) in the trajectory is given the reward. Only one reward is present for each trajectory.

The process trains the predictive model according to the training data set, wherein the predictive model predicts defect metrics for partial trajectories using partial trajectory regression (step 906). The process terminates thereafter.

In step 906, the predictive model can be selected from a group comprising a constrained-recurrent neural network (C-RNN), a sequential regression model, a neural network, a constrained neural network, a long-short term memory (LSTM) network, a transformer model, and other suitable types of models that can be implemented to handle partial trajectories.

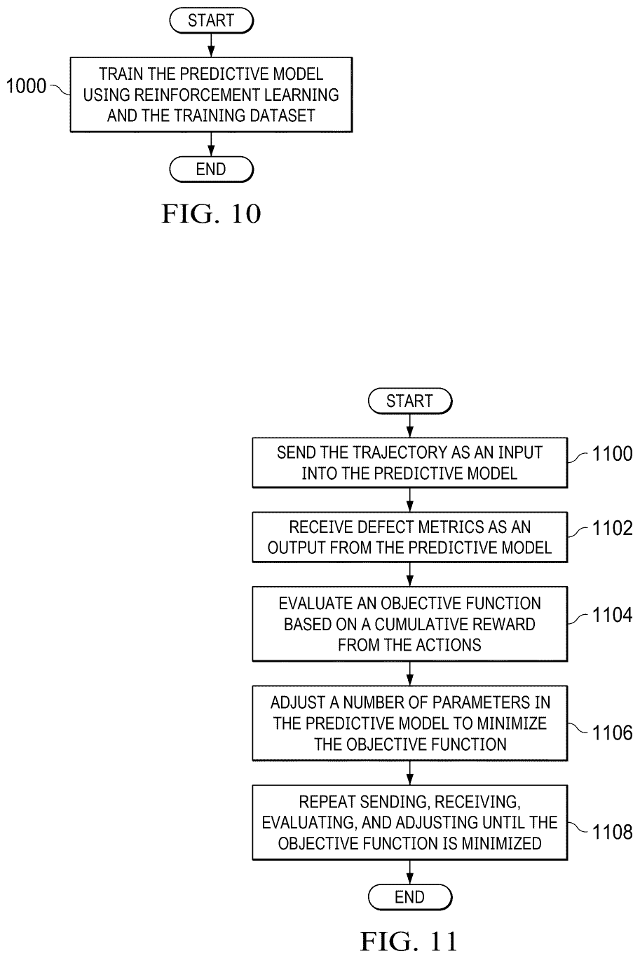

Turning now to FIG. 10, a flowchart of a process for training the predictive model is depicted in accordance with an illustrative embodiment. The process in this flowchart is an example of an implementation for step 906 in FIG. 9.

The process trains the predictive model using reinforcement learning and the training dataset (step 1000). The process terminates thereafter.

Next in FIG. 11, a flowchart of a process for training the predictive model is depicted in accordance with an illustrative embodiment. The process in this flowchart is an example of an implementation for step 906 in FIG. 9.

The process sends the trajectory as an input into the predictive model (step 1100). The process receives defect metrics as an output from the predictive model (step 1102). The process evaluates an objective function based on a cumulative reward from the actions (step 1104).

The process adjusts a number of parameters in the predictive model to minimize the objective function (operation 1106). In step 1106, the objective function uses cumulative rewards in the evaluation. The objective function is minimized when the predictions of defect metrics are close as desired such as within some threshold to the measured defect densities. In other words, minimizing the objective function means obtaining the smallest possible value from the objective function.

In other examples, the objective function can be considered minimized when the value of the objective function that falls within a predefined tolerance of the optimal solution. The process repeats sending, receiving, evaluating, and adjusting until the objective function is minimized (operation 1108). The process terminates thereafter.

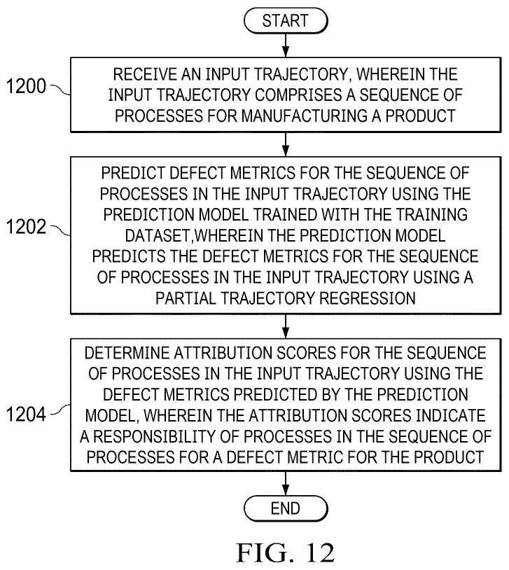

Turning to FIG. 12, a flowchart of a process for determining attribution scores is depicted in accordance with an illustrative embodiment. The process in this flowchart is an example of additional steps that can be performed with the steps in FIG. 9.

The process receives an input trajectory, wherein the input trajectory comprises a sequence of processes for manufacturing a product (step 1200). The process predicts defect metrics for the sequence of processes in the input trajectory using the prediction model trained with the training dataset, wherein the prediction model predicts the defect metrics for the sequence of processes in the input trajectory using a partial trajectory regression (step 1202).

The process determines attribution scores for the sequence of processes in the input trajectory using the defect metrics predicted by the prediction model, wherein the attribution scores indicate a responsibility of processes in the sequence of processes for a defect metric for the product (step 1204). The process terminates thereafter.

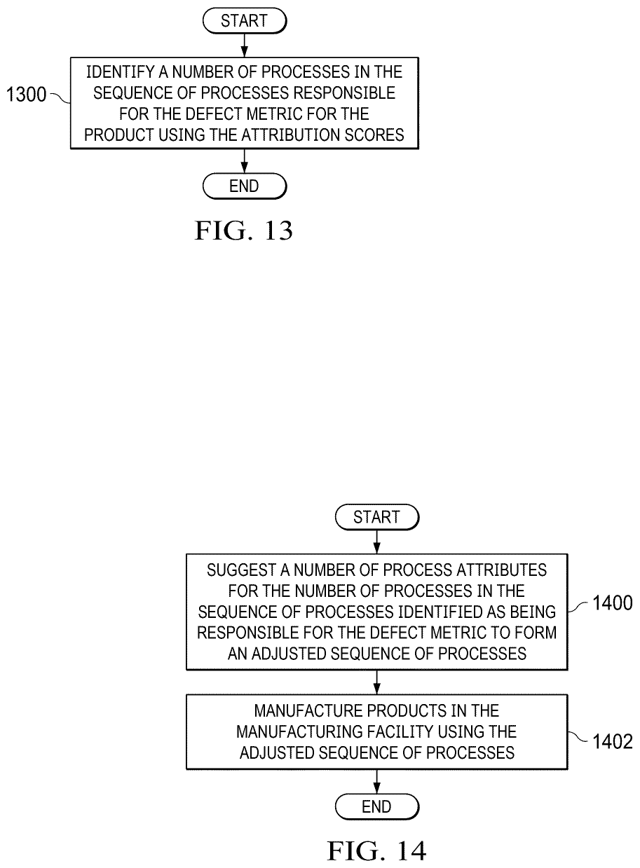

With reference to FIG. 13, a flowchart of a process for identifying responsible processes is depicted in accordance with an illustrative embodiment. The process in this flowchart is an example of additional steps that conform with the steps for the processes in FIG. 9 and FIG. 12.

The process identifies a number of processes in the sequence of processes responsible for the defect metric for the product using the attribution scores (step 1300). The process terminates thereafter.

Next in FIG. 14, a flowchart of a process for manufacturing products is depicted in accordance with an illustrative embodiment. The process in this flowchart is an example of additional steps that can be performed with the steps in FIG. 9, FIG. 12, and FIG. 13. In this flowchart, the sequence of processes in the input trajectory is for manufacturing products in a manufacturing facility.

The process suggests a number of process attributes for the number of processes in the sequence of processes identified as being responsible for the defect metric to form an adjusted sequence of processes (step 1400). The process manufactures products in the manufacturing facility using the adjusted sequence of processes (step 1402). The process terminates thereafter.

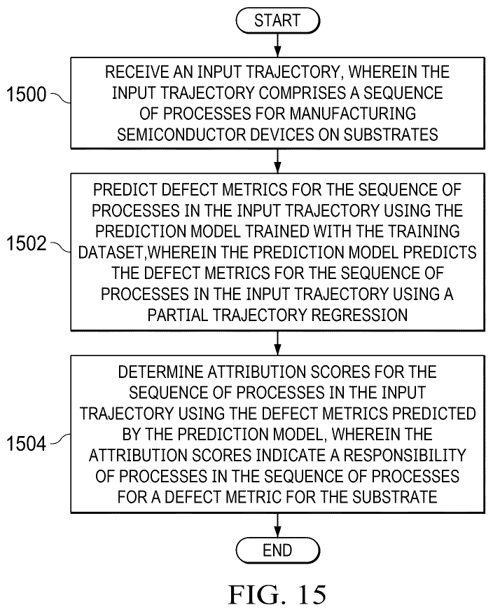

With reference now to FIG. 15, a flowchart of a process for determining attribution scores is depicted in accordance with an illustrative embodiment. The process in this flowchart is an example of steps that can be performed with the process in FIG. 9.

The process receives an input trajectory, wherein the input trajectory comprises a sequence of processes for manufacturing semiconductor devices on substrates (step 1500). The process predicts defect metrics for the sequence of processes in the input trajectory using the prediction model trained with the training dataset, wherein the prediction model predicts the defect metrics for the sequence of processes in the input trajectory using a partial trajectory regression (step 1502).

The process determines attribution scores for the sequence of processes in the input trajectory using the defect metrics predicted by the prediction model, wherein the attribution scores indicate a responsibility of processes in the sequence of processes for a defect metric for the substrate (step 1504). The process terminates thereafter.

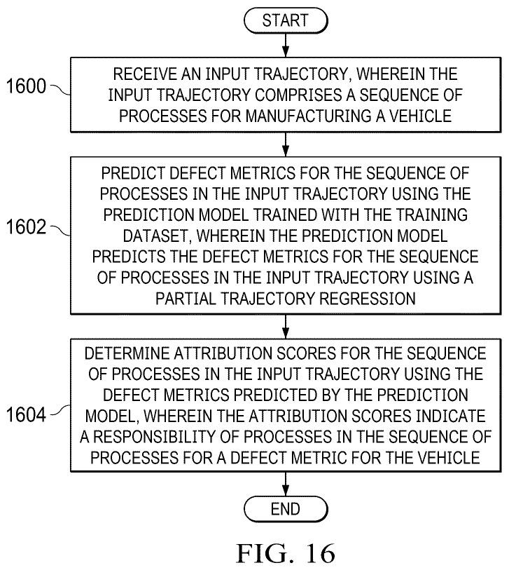

Next in FIG. 16, a flowchart of a process for determining attribution scores is depicted in accordance with an illustrative embodiment. The process in this flowchart is an example of steps that can be performed with the process in FIG. 9.

The process receives an input trajectory, wherein the input trajectory comprises a sequence of processes for manufacturing a vehicle (step 1600). The process predicts defect metrics for the sequence of processes in the input trajectory using the prediction model trained with the training dataset, wherein the prediction model predicts the defect metrics for the sequence of processes in the input trajectory using a partial trajectory regression (step 1602).

The process determines attribution scores for the sequence of processes in the input trajectory using the defect metrics predicted by the prediction model, wherein the attribution scores indicate a responsibility of processes in the sequence of processes for a defect metric for the vehicle (step 1604). The process terminates thereafter.

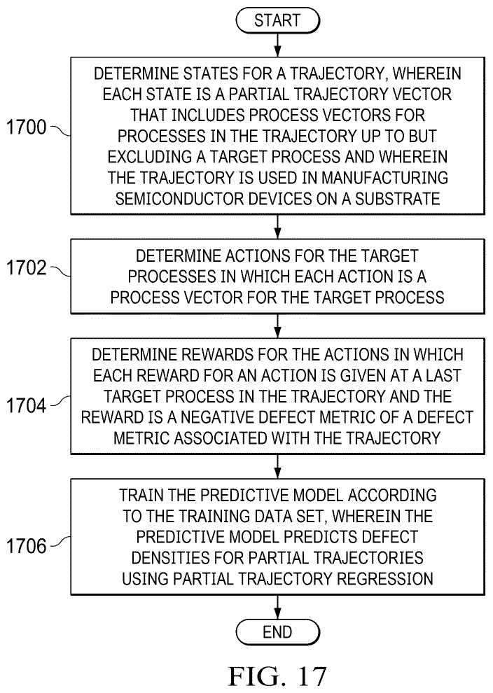

Turning next to FIG. 17, a flowchart of a process for training a predictive model is depicted in accordance with an illustrative embodiment. The process in FIG. 17 can be implemented in hardware, software, or both. When implemented in software, the process can take the form of program instructions that are run by a processor set located in one or more hardware devices in one or more computer systems. For example, the process can be implemented in partial trajectory regression model manager 814 in computer system 812 in FIG. 8.

The process determines states for a trajectory, wherein each state is a partial trajectory vector that includes process vectors for processes in the trajectory up to but excluding a target process and wherein the trajectory is used in manufacturing semiconductor devices on a substrate (step 1700). The process determines actions for the target processes in which each action is a process vector for the target process (step 1702). The process determines rewards for the actions in which each reward for an action is given at a last target process in the trajectory and the reward is a negative defect metric of a defect metric associated with the trajectory (step 1704). The training dataset comprises the states; the actions; the rewards; the trajectories used to determine the states, the actions, the rewards; and associated defect metrics for the trajectories.

The process trains the predictive model according to the training data set, wherein the predictive model predicts defect densities for partial trajectories using partial trajectory regression (step 1706). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. A Iso, other blocks can be added in addition to the illustrated blocks in a flowchart or block diagram.

According to one illustrative embodiment, a method is provided for training a partial trajectory regression model. States are determined for a trajectory. Each state is a partial trajectory vector that includes process vectors for processes in the trajectory up to but excluding a target process. Actions are determined for the target processes in which each action is a process vector for the target process. Rewards are determined for the actions in which each reward for an action is given at a last target process in the trajectory and the reward is a negative defect metric of a defect metric associated with the trajectory. The training dataset comprises the states; the actions; the rewards; the trajectories used to determine the states, the actions, the rewards, and associated defect metrics for the trajectories. The partial trajectory regression model is trained according to the training data set, wherein the partial trajectory regression model predicts defect metrics for partial trajectories using partial trajectory regression. As a result, the illustrative embodiments provide a technical effect enabling training partial trajectory regression models using rewards.

In the illustrative embodiments, the training comprises training the partial trajectory regression model using reinforcement learning and the training dataset Thus, the illustrative embodiments provide a technical effect of enabling training a partial trajectory regression model using reinforcement learning that has rewards based defect metrics.

In the illustrative embodiments, training comprises the method sending the trajectory as an input into the partial trajectory regression model. The method receives defect metrics as an output from the partial trajectory regression model. The method evaluates an objective function based on a cumulative reward from the actions. The method adjusts a number of parameters in the partial trajectory regression model to minimize the objective function. The method repeats sending, receiving, evaluating, and adjusting until the objective function is minimized. Thus, the illustrative embodiments provide a technical effect of enabling reinforcement learning for partial trajectory regression models.

In the illustrative embodiments, the method receives an input trajectory in which the input trajectory comprises a sequence of processes for manufacturing a product. The method predicts defect metrics for the sequence of processes in the input trajectory using the partial trajectory regression model trained with the training dataset. The partial trajectory regression model predicts the defect metrics for the sequence of processes in the input trajectory using a partial trajectory regression. The method determines attribution scores for the sequence of processes in the input trajectory using the defect metrics predicted by the partial trajectory regression model, wherein the attribution scores indicate a responsibility of processes in the sequence of processes for a defect metric for the product. As a result, the illustrative embodiments provide a technical effect of determining attribution scores using defect metrics predicted by a partial trajectory regression model

In the illustrative embodiments, the method identifies a number of processes in the sequence of processes responsible for the defect metric for the product using the attribution scores. Thus, the illustrative embodiments provide a technical effect of determining one or more processes responsible for the defect metric of a product.

In the illustrative embodiments, the sequence of processes in the input trajectory is for manufacturing products in a manufacturing system. The method adjusts a number of process attributes for the number of processes in the sequence of processes identified as being responsible for the defect metric to form an adjusted sequence of processes. The method manufactures products in the manufacturing system using the adjusted sequence of processes. Thus, the illustrative embodiments provide a technical effect of manufacturing products with less defects.

In the illustrative embodiments, the method receives an input trajectory in which the input trajectory comprises a sequence of processes for manufacturing semiconductor devices on substrates. The method predicts defect metrics for the sequence of processes in the input trajectory using the partial trajectory regression model trained with the training dataset. The partial trajectory regression model predicts the defect metrics for the sequence of processes in the input trajectory using a partial trajectory regression. The method determines attribution scores for the sequence of processes in the input trajectory using the defect metrics predicted by the partial trajectory regression model, wherein the attribution scores indicate a responsibility of processes in the sequence of processes for a defect metric for the substrate. As a result, the illustrative embodiments provide a technical effect of determining processes responsible for a defect metric for a substrate.

In the illustrative embodiments, the method receives an input trajectory, wherein the input trajectory comprises a sequence of processes for manufacturing a vehicle. The method predicts defect metrics for the sequence of processes in the input trajectory using the partial trajectory regression model trained with the training dataset. The partial trajectory regression model predicts the defect metrics for the sequence of processes in the input trajectory using a partial trajectory regression. The method determines attribution scores for the sequence of processes in the input trajectory using the defect metrics predicted by the partial trajectory regression model. The attribution scores indicate a responsibility of processes in the sequence of processes for a defect metric for the vehicle. Thus, illustrative embodiments provide a technical effect of determining processes responsible for a defect metric for the vehicle.

According to another illustrative embodiment, a method trains a partial trajectory regression model. The method determines states for a trajectory. Each state is a partial trajectory vector that includes process vectors for processes in the trajectory up to but excluding a target process. The trajectory is used in manufacturing semiconductor devices on a substrate. The method determines actions for the target processes in which each action is a process vector for the target process. The method determines rewards for the actions in which each reward for an action is given at a last target process in the trajectory and the reward is a negative defect metric of a defect metric associated with the trajectory. A training dataset comprises the states; the actions; the rewards; the trajectories used to determine the states, the actions, the rewards; and associated defect metrics for the trajectories. The method trains the partial trajectory regression model according to the training data set, wherein the partial trajectory regression model predicts defect densities for partial trajectories using partial trajectory regression. Thus, the illustrative embodiments provide a technical effect of training a partial trajectory regression model according to a training dataset derived from trajectories and corresponding defect metrics.

According to one illustrative embodiment, a computer system comprises processor set; a set of one or more computer-readable storage media; and program instructions stored in the set of one or more storage media to cause the processor set to perform operations. The program instructions cause the processor set to determines states for a trajectory. Each state is a partial trajectory vector that includes process vectors for processes in the trajectory up to but excluding a target process. The program instructions cause the processor set to determines actions for the target processes in which each action is a process vector for the target process. The program instructions cause the processor set to determines rewards for the actions in which each reward for an action is given at a last target process in the trajectory and the reward is a negative defect metric of a defect metric associated with the trajectory. A training dataset comprises the states; the actions; the rewards; the trajectories used to determine the states, the actions, the rewards; and associated defect metrics for the trajectories. The program instructions cause the processor set to train the partial trajectory regression model according to the training data set, wherein the partial trajectory regression model predicts defect metrics for partial trajectories using partial trajectory regression. As a result, the illustrative embodiments provide a technical effect enabling training partial trajectory regression models using rewards.

In the illustrative embodiments, wherein as part of training the partial trajectory regression model, the program instructions cause the processor set to train the partial trajectory regression model using reinforcement learning and the training dataset. Thus, the illustrative embodiments provide a technical effect of enabling training a partial trajectory regression model using reinforcement learning that has rewards based defect metrics.

In the illustrative embodiments, as part of training the partial trajectory regression model, the program instructions cause the processor set to send the trajectory as an input into the partial trajectory regression model. The program instructions cause the processor set to receive defect metrics as an output from the partial trajectory regression model. The program instructions cause the processor set to evaluate an objective function based on a cumulative reward from the actions. The program instructions cause the processor set to adjust a number of parameters in the partial trajectory regression model to minimize the objective function. The program instructions cause the processor set to repeat sending, receiving, evaluating, and adjusting until the objective function is minimized. Thus, the illustrative embodiments provide a technical effect of enabling reinforcement learning for partial trajectory regression models.

In the illustrative embodiments, the program instructions cause the processor set to receive an input trajectory, wherein the input trajectory comprises a sequence of processes for manufacturing a product. The program instructions cause the processor set to predict defect metrics for the sequence of processes in the input trajectory using the partial trajectory regression model trained with the training dataset. The partial trajectory regression model predicts the defect metrics for the sequence of processes in the input trajectory using a partial trajectory regression. The program instructions cause the processor set to determine attribution scores for the sequence of processes in the input trajectory using the defect metrics predicted by the partial trajectory regression model, wherein the attribution scores indicate a responsibility of processes in the sequence of processes for a defect metric for the product. As a result, the illustrative embodiments provide a technical effect of determining attribution scores using defect metrics predicted by a partial trajectory regression model.

In the illustrative embodiments, the program instructions cause the processor set to identify a number of processes in the sequence of processes responsible for the defect metric using the attribution scores. Thus, the illustrative embodiments provide a technical effect of determining one or more processes responsible for the defect metric of a product.

In the illustrative embodiments, the sequence of processes in the input trajectory is manufacturing products in a manufacturing system. The program instructions cause the processor set to adjust a number of process attributes for the number of processes in the sequence of processes identified as being responsible for the defect metric to form an adjusted sequence of processes. The program instructions cause the processor set to manufacture products in the manufacturing system using the adjusted sequence of processes. Thus, the illustrative embodiments provide a technical effect of manufacturing products with less defects

In the illustrative embodiments, the program instructions cause the processor set to receive an input trajectory, wherein the input trajectory comprises a sequence of processes for manufacturing semiconductor devices on substrates. The program instructions cause the processor set to predict defect metrics for the sequence of processes in the input trajectory using the partial trajectory regression model trained with the training dataset. The partial trajectory regression model predicts the defect metrics for the sequence of processes in the input trajectory using a partial trajectory regression. The program instructions cause the processor set to determine attribution scores for the sequence of processes in the input trajectory using the defect metrics predicted by the partial trajectory regression model. The attribution scores indicate a responsibility of processes in the sequence of processes for a defect metric for the substrate. As a result, the illustrative embodiments provide a technical effect of determining processes responsible for a defect metric for a substrate.

In the illustrative embodiments, the program instructions cause the processor set to receive an input trajectory, wherein the input trajectory comprises a sequence of processes for manufacturing a vehicle. The program instructions cause the processor set to predict defect metrics for the sequence of processes in the input trajectory using the partial trajectory regression model trained with the training dataset. The partial trajectory regression model predicts the defect metrics for the sequence of processes in the input trajectory using a partial trajectory regression. The program instructions cause the processor set to determine attribution scores for the sequence of processes in the input trajectory using the defect metrics predicted by the partial trajectory regression model, wherein the attribution scores indicate a responsibility of processes in the sequence of processes for a defect metric for the vehicle. Thus, illustrative embodiments provide a technical effect of determining processes responsible for a defect metric for the vehicle.

According to another illustrative embodiment, a computer system comprises a processor set; a set of one or more computer-readable storage media; and program instructions stored in the set of one or more storage media to cause the processor set to perform operations. The program instructions cause the processor set to determine states for a trajectory. Each state is a partial trajectory vector that includes process vectors for processes in the trajectory up to but excluding a target process The trajectory is used in manufacturing semiconductor devices on a substrate. The program instructions cause the processor set to determine actions for the target processes in which each action is a process vector for the target process. The program instructions cause the processor set to determine rewards for the actions in which each reward for an action is given at a last target process in the trajectory and the reward is a negative defect metric of a defect metric associated with the trajectory. A training dataset comprises the states; the actions; the rewards; the trajectories used to determine the states, the actions, the rewards, and associated defect metrics for the trajectories. The program instructions cause the processor set to train the partial trajectory regression model according to the training data set. The partial trajectory regression model predicts defect densities for partial trajectories using partial trajectory regression. Thus, the illustrative embodiments provide a technical effect of training a partial trajectory regression model according to a training dataset derived from trajectories and corresponding defect metrics.

According to another illustrative embodiment, a computer program product is used to train training a partial trajectory regression model. The computer program product comprises one or more computer-readable storage media; and program instructions stored on the one or more computer-readable storage media to perform operations. The program instructions cause a processor set to determine states for a trajectory, wherein each state is a partial trajectory vector that includes process vectors for processes in the trajectory up to but excluding a target process. The program instructions cause the processor set to determine actions for the target processes in which each action is a process vector for the target process. The program instructions cause the processor set to determine rewards for the actions in which each reward for an action is given at a last target process in the trajectory and the reward is a negative defect metric of a defect metric associated with the trajectory. A training dataset comprises the states; the actions; the rewards; the trajectories used to determine the states, the actions, the rewards; and associated defect metrics for the trajectories. The program instructions cause the processor set to train the partial trajectory regression model according to the training data set, wherein the partial trajectory regression model predicts defect metrics for partial trajectories using partial trajectory regression. Thus, the illustrative embodiments provide a technical effect of training a partial trajectory regression model according to a training dataset derived from trajectories and corresponding defect metrics.

In the illustrative embodiments, wherein as part of training the partial trajectory regression model, The program instructions cause the processor set to train the partial trajectory regression model using reinforcement learning and the training dataset. Thus, the illustrative embodiments provide a technical effect of training a partial trajectory regression model according to a training dataset derived from trajectories and corresponding defect metrics. reinforcement learning and the training dataset.

In the illustrative embodiments, the program instructions cause the processor set to receive an input trajectory in which the input trajectory comprises a sequence of processes for manufacturing semiconductor devices on substrates. The program instructions cause the processor set to predict defect metrics for the sequence of processes in the input trajectory using the partial trajectory regression model trained with the training dataset. The partial trajectory regression model predicts the defect metrics for the sequence of processes in the input trajectory using a partial trajectory regression. The program instructions cause the processor set to determine attribution scores for the sequence of processes in the input trajectory using the defect metrics predicted by the partial trajectory regression model. The attribution scores indicate a responsibility of processes in the sequence of processes for a defect metric for the substrate. Thus, illustrative embodiments provide a technical effect of determining processes responsible for a defect metric for the substrate.

In the illustrative embodiments, the program instructions cause the processor set to receive an input trajectory in which the input trajectory comprises a sequence of processes for manufacturing a vehicle. The program instructions cause the processor set to predict defect metrics for the sequence of processes in the input trajectory using the partial trajectory regression model trained with the training dataset, wherein the partial trajectory regression model predicts the defect metrics for the sequence of processes in the input trajectory using a partial trajectory regression. The program instructions cause the processor set to determine attribution scores for the sequence of processes in the input trajectory using the defect metrics predicted by the partial trajectory regression model, wherein the attribution scores indicate a responsibility of processes in the sequence of processes for a defect metric for the vehicle. Thus, illustrative embodiments provide a technical effect of determining processes responsible for a defect metric for the vehicle.

In the illustrative embodiments, the program instructions cause the processor set to identify a number of processes in the sequence of processes responsible for the defect metric using the attribution scores. Thus, the illustrative embodiments provide a technical effect of determining one or more processes responsible for the defect metric of a product.

In the illustrative embodiments, the sequence of processes in the input trajectory is manufacturing products in a manufacturing system. The program instructions cause the processor set to adjust a number of process attributes for the number of processes in the sequence of processes identified as being responsible for the defect metric to form an adjusted sequence of processes. The program instructions cause the processor set to manufacture products in the manufacturing system using the adjusted sequence of processes. Thus, the illustrative embodiments provide a technical effect of manufacturing products with less defects.

In the illustrative embodiments: the program instructions cause the processor set to receive an input trajectory, wherein the input trajectory comprises a sequence of processes for manufacturing semiconductor devices on a substrate. The program instructions cause the processor set to predict defect metrics for the sequence of processes in the input trajectory using the partial trajectory regression model trained with the training dataset. The partial trajectory regression model predicts the defect metrics for the sequence of processes in the input trajectory using a partial trajectory regression. The program instructions cause the processor set to determine attribution scores for the sequence of processes in the input trajectory using the defect metrics predicted by the partial trajectory regression model. The attribution scores indicate a responsibility of processes in the sequence of processes for a defect metric for the substrate. As a result, the illustrative embodiments provide a technical effect of determining processes responsible for a defect metric for a substrate.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. M any modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for training a partial trajectory regression model, the method comprising:
determining states for a trajectory, wherein each state is a partial trajectory vector that includes process vectors for processes in the trajectory up to but excluding a target process;
determining actions for the target processes in which each action is a process vector for the target process;
determining rewards for the actions in which each reward for an action is given at a last target process in the trajectory and the reward is a negative defect metric of a defect metric associated with the trajectory, wherein a training dataset comprises:
the states;
the actions;
the rewards;
the trajectories used to determine the states, the actions, the rewards, and associated defect metrics for the trajectories; and
training the partial trajectory regression model according to the training data set, wherein the partial trajectory regression model predicts defect metrics for partial trajectories using partial trajectory regression.

2. The method of claim 1, where training comprises:
training the partial trajectory regression model using reinforcement learning and the training dataset.

3. The method of claim 1, wherein training comprises:
sending the trajectory as an input into the partial trajectory regression model;
receiving defect metrics as an output from the partial trajectory regression model;
evaluating an objective function based on a cumulative reward from the actions;
adjusting a number of parameters in the partial trajectory regression model to minimize the objective function; and
repeating sending, receiving, evaluating, and adjusting until the objective function is minimized.

4. The method of claim 1, further comprising:
receiving an input trajectory, wherein the input trajectory comprises a sequence of processes for manufacturing a product;
predicting defect metrics for the sequence of processes in the input trajectory using the partial trajectory regression model trained with the training dataset, wherein the partial trajectory regression model predicts the defect metrics for the sequence of processes in the input trajectory using a partial trajectory regression; and
determining attribution scores for the sequence of processes in the input trajectory using the defect metrics predicted by the partial trajectory regression model, wherein the attribution scores indicate a responsibility of processes in the sequence of processes for a defect metric for the product.

5. The method of claim 4 further comprising:
identifying a number of processes in the sequence of processes responsible for the defect metric for the product using the attribution scores.

6. The method of claim 5, wherein the sequence of processes in the input trajectory is for manufacturing products in a manufacturing system and further comprising:
adjusting a number of process attributes for the number of processes in the sequence of processes identified as being responsible for the defect metric to form an adjusted sequence of processes; and
manufacturing products in the manufacturing system using the adjusted sequence of processes.

7. The method of claim 1 further comprising:
receiving an input trajectory, wherein the input trajectory comprises a sequence of processes for manufacturing semiconductor devices on substrates;
predicting defect metrics for the sequence of processes in the input trajectory using the partial trajectory regression model trained with the training dataset, wherein the partial trajectory regression model predicts the defect metrics for the sequence of processes in the input trajectory using a partial trajectory regression; and
determining attribution scores for the sequence of processes in the input trajectory using the defect metrics predicted by the partial trajectory regression model, wherein the attribution scores indicate a responsibility of processes in the sequence of processes for a defect metric for the substrate.

8. The method of claim 1 further comprising:
receiving an input trajectory, wherein the input trajectory comprises a sequence of processes for manufacturing a vehicle;
predicting defect metrics for the sequence of processes in the input trajectory using the partial trajectory regression model trained with the training dataset, wherein the partial trajectory regression model predicts the defect metrics for the sequence of processes in the input trajectory using a partial trajectory regression; and
determining attribution scores for the sequence of processes in the input trajectory using the defect metrics predicted by the partial trajectory regression model, wherein the attribution scores indicate a responsibility of processes in the sequence of processes for a defect metric for the vehicle.

9. A method for training a partial trajectory regression model, the method comprising:
determining states for a trajectory, wherein each state is a partial trajectory vector that includes process vectors for processes in the trajectory up to but excluding a target process and wherein the trajectory is used in manufacturing semiconductor devices on a substrate;
determining actions for the target processes in which each action is a process vector for the target process;
determining rewards for the actions in which each reward for an action is given at a last target process in the trajectory and the reward is a negative defect metric of a defect metric associated with the trajectory, wherein a training dataset comprises:
the states;
the actions;
the rewards;
the trajectories used to determine the states, the actions, the rewards; and associated defect metrics for the trajectories; and
training the partial trajectory regression model according to the training data set, wherein the partial trajectory regression model predicts defect densities for partial trajectories using partial trajectory regression.

10. A computer system comprising:
a processor set;
a set of one or more computer-readable storage media; and
program instructions stored in the set of one or more storage media to cause the processor set to perform operations comprising:
determining states for a trajectory, wherein each state is a partial trajectory vector that includes process vectors for processes in the trajectory up to but excluding a target process;
determining actions for the target processes in which each action is a process vector for the target process;
determining rewards for the actions in which each reward for an action is given at a last target process in the trajectory and the reward is a negative defect metric of a defect metric associated with the trajectory, wherein a training dataset comprises:
the states;
the actions;
the rewards;
the trajectories used to determine the states, the actions, the rewards; and associated defect metrics for the trajectories; and
training the partial trajectory regression model according to the training data set, wherein the partial trajectory regression model predicts defect metrics for partial trajectories using partial trajectory regression.

11. The computer system of claim 10, wherein as part of training the partial trajectory regression model, the operation comprise:
training the partial trajectory regression model using reinforcement learning and the training dataset.

12. The computer system of claim 10, wherein as part of training the partial trajectory regression model, the operation comprise:
sending the trajectory as an input into the partial trajectory regression model;
receiving defect metrics as an output from the partial trajectory regression model; evaluating an objective function based on a cumulative reward from the actions;
adjusting a number of parameters in the partial trajectory regression model to minimize the objective function; and
repeating sending, receiving, evaluating, and adjusting until the objective function is minimized.

13. The computer system of claim 10, wherein the operations further comprise:
receiving an input trajectory, wherein the input trajectory comprises a sequence of processes for manufacturing a product;
predicting defect metrics for the sequence of processes in the input trajectory using the partial trajectory regression model trained with the training dataset, wherein the partial trajectory regression model predicts the defect metrics for the sequence of processes in the input trajectory using a partial trajectory regression; and
determining attribution scores for the sequence of processes in the input trajectory using the defect metrics predicted by the partial trajectory regression model, wherein the attribution scores indicate a responsibility of processes in the sequence of processes for a defect metric for the product.

14. The computer system of claim 13, wherein the operations further comprise:
identifying a number of processes in the sequence of processes responsible for the defect metric using the attribution scores.

15. The computer system of claim 14, wherein the sequence of processes in the input trajectory is manufacturing products in a manufacturing system, and wherein the operations further comprise:
adjusting a number of process attributes for the number of processes in the sequence of processes identified as being responsible for the defect metric to form an adjusted sequence of processes; and
manufacturing products in the manufacturing system using the adjusted sequence of processes.

16. The computer system of claim 10, wherein the operations further comprise:
receiving an input trajectory, wherein the input trajectory comprises a sequence of processes for manufacturing semiconductor devices on substrates;
predicting defect metrics for the sequence of processes in the input trajectory using the partial trajectory regression model trained with the training dataset, wherein the partial trajectory regression model predicts the defect metrics for the sequence of processes in the input trajectory using a partial trajectory regression; and
determining attribution scores for the sequence of processes in the input trajectory using the defect metrics predicted by the partial trajectory regression model, wherein the attribution scores indicate a responsibility of processes in the sequence of processes for a defect metric for the substrate.

17. The computer system of claim 10, wherein the operations further comprise:
receiving an input trajectory, wherein the input trajectory comprises a sequence of processes for manufacturing a vehicle;
predicting defect metrics for the sequence of processes in the input trajectory using the partial trajectory regression model trained with the training dataset, wherein the partial trajectory regression model predicts the defect metrics for the sequence of processes in the input trajectory using a partial trajectory regression; and
determining attribution scores for the sequence of processes in the input trajectory using the defect metrics predicted by the partial trajectory regression model, wherein the attribution scores indicate a responsibility of processes in the sequence of processes for a defect metric for the vehicle.

18. A computer system comprising:
a processor set;
a set of one or more computer-readable storage media; and
program instructions stored in the set of one or more storage media to cause the processor set to perform operations comprising:
determining states for a trajectory, wherein each state is a partial trajectory vector that includes process vectors for processes in the trajectory up to but excluding a target process and wherein the trajectory is used in manufacturing semiconductor devices on a substrate;
determining actions for the target processes in which each action is a process vector for the target process;
determining rewards for the actions in which each reward for an action is given at a last target process in the trajectory and the reward is a negative defect metric of a defect metric associated with the trajectory, wherein a training dataset comprises:
the states;
the actions;
the rewards;
the trajectories used to determine the states, the actions, the rewards, and associated defect metrics for the trajectories; and
training the partial trajectory regression model according to the training data set, wherein the partial trajectory regression model predicts defect densities for partial trajectories using partial trajectory regression.

19. A computer program product for training a partial trajectory regression model, the computer program product comprising:
one or more computer-readable storage media; and
program instructions stored on the one or more computer-readable storage media to perform operations comprising:
determining states for a trajectory, wherein each state is a partial trajectory vector that includes process vectors for processes in the trajectory up to but excluding a target process;
determining actions for the target processes in which each action is a process vector for the target process;
determining rewards for the actions in which each reward for an action is given at a last target process in the trajectory and the reward is a negative defect metric of a defect metric associated with the trajectory, wherein a training dataset comprises:
the states;
the actions;
the rewards;
the trajectories used to determine the states, the actions, the rewards; and
associated defect metrics for the trajectories; and
training the partial trajectory regression model according to the training data set, wherein the partial trajectory regression model predicts defect metrics for partial trajectories using partial trajectory regression.

20. The computer program product of claim 19, wherein as part of training the partial trajectory regression model, the operations comprise:
training the partial trajectory regression model using reinforcement learning and the training dataset.

21. The computer program product of claim 19, wherein the operations further comprise:
receiving an input trajectory, wherein the input trajectory comprises a sequence of processes for manufacturing semiconductor devices on substrates;
predicting defect metrics for the sequence of processes in the input trajectory using the partial trajectory regression model trained with the training dataset, wherein the partial trajectory regression model predicts the defect metrics for the sequence of processes in the input trajectory using a partial trajectory regression; and
determining attribution scores for the sequence of processes in the input trajectory using the defect metrics predicted by the partial trajectory regression model, wherein the attribution scores indicate a responsibility of processes in the sequence of processes for a defect metric for the substrate.

22. The computer program product of claim 19, wherein the operations further comprise:
receiving an input trajectory, wherein the input trajectory comprises a sequence of processes for manufacturing a vehicle;
predicting defect metrics for the sequence of processes in the input trajectory using the partial trajectory regression model trained with the training dataset, wherein the partial trajectory regression model predicts the defect metrics for the sequence of processes in the input trajectory using a partial trajectory regression; and
determining attribution scores for the sequence of processes in the input trajectory using the defect metrics predicted by the partial trajectory regression model, wherein the attribution scores indicate a responsibility of processes in the sequence of processes for a defect metric for the vehicle.

23. The computer program product of claim 22, wherein the operations further comprise:
identifying a number of processes in the sequence of processes responsible for the defect metric using the attribution scores.

24. The computer program product of claim 23, wherein the sequence of processes in the input trajectory is manufacturing products in a manufacturing system and wherein the operations further comprise:
adjusting a number of process attributes for the number of processes in the sequence of processes identified as being responsible for the defect metric to form an adjusted sequence of processes; and
manufacturing products in the manufacturing system using the adjusted sequence of processes.

25. The computer program product of claim 19, wherein the operations further comprise:
receiving an input trajectory, wherein the input trajectory comprises a sequence of processes for manufacturing semiconductor devices on a substrate;
predicting defect metrics for the sequence of processes in the input trajectory using the partial trajectory regression model trained with the training dataset, wherein the partial trajectory regression model predicts the defect metrics for the sequence of processes in the input trajectory using a partial trajectory regression; and
determining attribution scores for the sequence of processes in the input trajectory using the defect metrics predicted by the partial trajectory regression model, wherein the attribution scores indicate a responsibility of processes in the sequence of processes for a defect metric for the substrate.
